(19) United States
(12) Patent Application Publication
(10) Pub. No.: US 2026/0206722 A1
(43) Pub. Date: Jul. 23, 2026

(54) PET TOY

(71) Applicant: Steve Panza, Lafayette, IN (US)

(72) Inventor: Steve Panza, Lafayette, IN (US)

(21) Appl. No.: 19/453,766

(22) Filed: Jan. 20, 2026

Related U.S. Application Data
(60) Provisional application No. 63/748,411, filed on Jan. 22, 2025.

(51) Int. Cl. A01K 15/02

(52) U.S. Cl. CPC A01K 15/0252; A01K 15/026

(57) ABSTRACT

A pet toy includes a clamshell having two half spheres coupled together through an integral hinge. The clamshell is movable between a closed configuration and an open configuration. In the closed configuration, the clamshell is a sphere having an outer surface that is continuous and interrupted only by a slit that extends through the wall thickness of the clamshell around a portion of the circumference of the clamshell. The clamshell is made of a single, integrally formed piece. The outer and inner surfaces of the two half spheres may be smooth or textured. The clamshell may be made of a material that is pliable and safe for a pet to chew, such as silicone or rubber.

### CROSS-REFERENCE TO RELATED APPLICATIONS

This Application claims priority to U.S. Provisional Ser. No. 63/748,411 filed on Jan. 22, 2025, entitled “Pet Toy,” the contents of which are incorporated herein by reference.

### BACKGROUND

### Field of the Art

The present invention is related to the field of pet toys. In particular, the present invention is related to a throwable toy for a dog.

### Discussion of the State of the Art

Dogs have long been valued companions for humans, and interactive play represents a critical component of maintaining canine physical health and mental stimulation. Engaging dogs in activities such as fetching and chasing provides essential exercise while strengthening the bond between pets and their owners. However, a significant portion of the canine population demonstrates little to no interest in pursuing and retrieving conventional play objects, leaving many pet owners without effective means to exercise and entertain their dogs.

In addition to the problem of lack of interest, traditional fetch toys, particularly tennis balls, present several drawbacks that limit their effectiveness and safety. The felt covering commonly found on tennis balls acts as an abrasive surface that, with repeated use, can gradually wear down a dog's tooth enamel. This dental degradation may lead to increased tooth sensitivity, vulnerability to decay, and potential long-term oral health complications. Despite widespread awareness of this issue among veterinary professionals, tennis balls remain one of the most commonly used dog toys due to their availability and low cost.

Disc-shaped toys designed for dogs present their own set of challenges. When these toys land on flat surfaces such as grass, pavement, or flooring, they typically rest flush against the ground, creating a profile that is difficult for dogs to grasp with their mouths. Dogs must often paw at the toy repeatedly or attempt to slide their teeth beneath the edge to gain purchase, which can lead to frustration and disengagement from play. This design limitation reduces the overall enjoyment and effectiveness of fetch activities.

While some toys have incorporated features like squeakers or treat dispensers to encourage play, these additions can be challenging to integrate into certain toy designs and may not address the fundamental problem of engaging a dog's natural instincts. Conventional dog toys generally fail to replicate the erratic, unpredictable movement patterns exhibited by small prey animals. Dogs possess deeply ingrained predatory instincts that respond to specific visual and motion cues associated with potential prey. When toys move in predictable, linear trajectories or remain stationary, they fail to trigger the neurological responses that drive enthusiastic chase behavior in canines. As a result, there remains a need for a dog toy that effectively mimics the movement of prey, is easy for dogs to pick up, and does not pose a risk to the dog's dental health.

### SUMMARY

The present invention is a throwable pet toy designed to attract and maintain a pet's interest in chasing and retrieving the toy. The toy is constructed from a flexible, durable material such as silicone or rubber, and features a unique clamshell shape with a living hinge connecting the two halves. This design allows the toy to rotate and flip in the air when thrown, mimicking the natural movement of prey animals and effectively stimulating a pet's chase instinct.

The clamshell shape of the toy also makes it easy for dogs to pick up from the ground, as it maintains its form and does not lie flat like traditional disc-shaped toys. This feature encourages dogs to engage with the toy and continue playing even after it has been retrieved.

Unlike tennis balls, which have an abrasive felt covering that can wear down a dog's tooth enamel over time, the present invention is made from a pliable material that poses no risk to the dog's dental health. The toy may also incorporate a textured surface on the inside of the clamshell to aid in teeth cleaning during play.

The toy offers enhanced safety through its material composition. The flexible material may be formulated to be BPA-free, phthalate-free, latex-free, tack-free, and non-adhesive, ensuring maximum safety for pets during extended play sessions. The semi-rigid construction allows the toy to deform upon impact but return to its manufactured shape, reducing the risk of injury while maintaining structural integrity over repeated use.

Additional benefits include the lightweight, hollow ball configuration when in the closed position, which facilitates easy throwing by pet owners of varying strength and ability. The toy may include an optional, inwardly-protruding lip formed around the peripheral edges of the half spheres, which facilitates handling by both the pet and the human thrower. The material may be impregnated with scents or flavors that are pleasing to pets, further enhancing attraction and engagement.

In one example, the present invention is a pet toy that includes a clamshell comprising two half spheres coupled together with a living hinge. The two half spheres may be the same size and shape as each other. The clamshell has an outer surface, an inner surface, and a wall thickness. The clamshell is configured to move between a closed configuration and an open configuration. The living hinge may be configured to bias the clamshell in the closed configuration. The clamshell in the closed configuration is a sphere having a circumference, which may be approximately 6 to 13 inches. The outer surface of the clamshell in the closed configuration is continuous and interrupted only by a slit that extends through the wall thickness of the clamshell around a portion of the circumference. The slit may extend around 70%-95% of the circumference of the sphere. The clamshell is made of a single, integrally formed piece. The clamshell may be made of rubber or silicone. Each one of the two half spheres may include a lip around a peripheral edge thereof. The outer and inner surfaces of the clamshell may be smooth or may have a rough texture. The clamshell may be made by injection molding, compression molding, thermoforming, or 3D printing.

By effectively addressing the problems of attracting a dog's interest, facilitating easy retrieval, and promoting dental health, the pet toy of the present invention represents a significant improvement over prior art dog toys. The unique design and material choice of the pet toy provide a more engaging and safer play experience for dogs and their owners.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a top plan view of an outside surface of a pet toy in an open configuration, in accordance with an embodiment of the present invention.

FIG. 2 is an elevation view of the outside surface of a pet toy in a substantially open configuration, in accordance with an embodiment of the present invention.

FIG. 3 is a perspective view of the inside surface of a pet toy in an open configuration, in accordance with an embodiment of the present invention.

FIG. 4 is a perspective view of the outside surface of a pet toy in a partially open configuration, in accordance with an embodiment of the present invention.

FIG. 5 is a perspective view of the inside surface of a pet toy in a partially open configuration, in accordance with an embodiment of the present invention.

FIG. 6 is an elevation view of a pet toy in a closed configuration, in accordance with an embodiment of the present invention.

FIG. 7 illustrates a pet toy in use, in accordance with an embodiment of the present invention.

### DETAILED DESCRIPTION

The present invention is a throwable pet toy that includes a clamshell having two half spheres coupled together through an integral hinge. The clamshell is movable between a closed configuration and an open configuration. The hinge may be constructed so that the clamshell is biased to be in the closed configuration. In the closed configuration, the clamshell is a sphere having an outer surface that is continuous and interrupted only by a slit that extends through the wall thickness of the clamshell around a portion of the circumference of the clamshell. The clamshell is made of a single, integrally formed piece. The outer and inner surfaces of the two half spheres may be smooth or textured. The clamshell may be made of a material that is pliable and safe for a pet to chew, such as silicone or rubber.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Apparatus

The pet toy of the present invention has a clamshell shape that includes two half spheres coupled together with a living hinge made of the same material as the half spheres. The clamshell is moveable between a closed configuration and an open configuration and may be biased to be in the closed configuration. The pet toy is formed of a single, unitary piece made of the same material throughout the toy. The pet toy is easy to throw and easy for the pet to pick up.

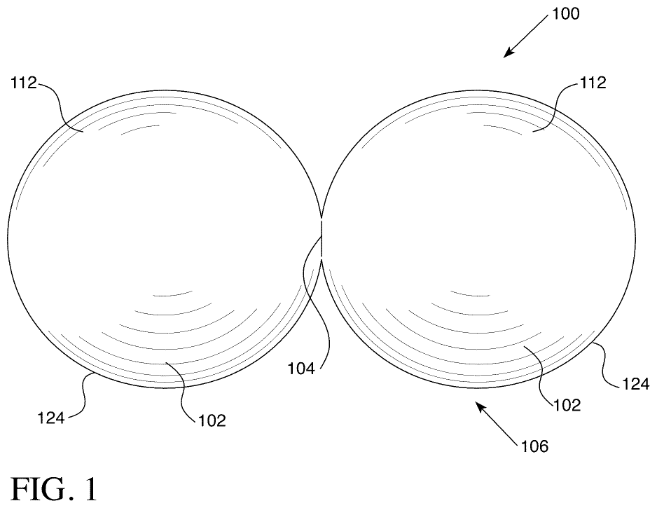

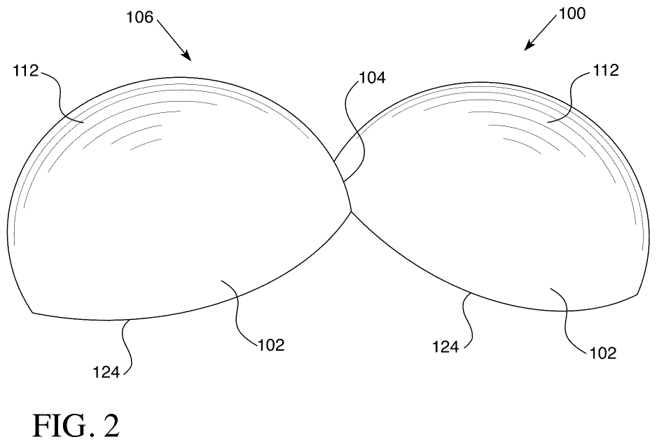

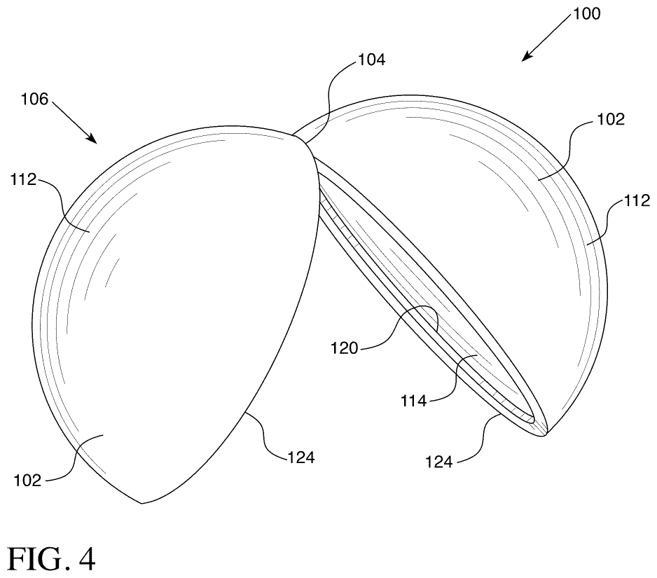

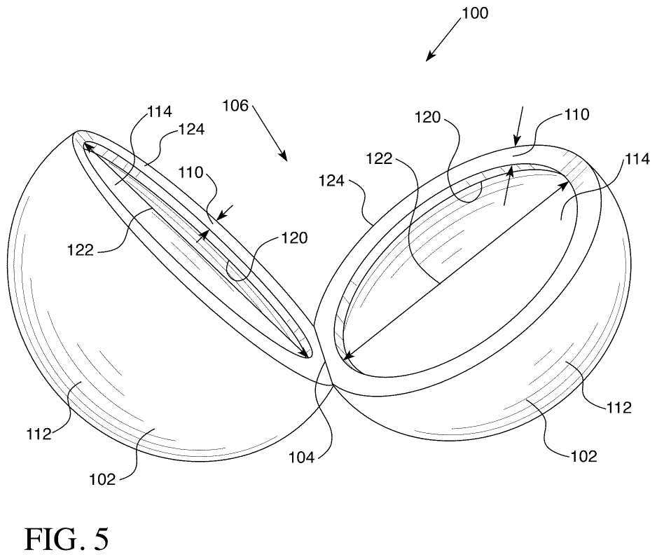

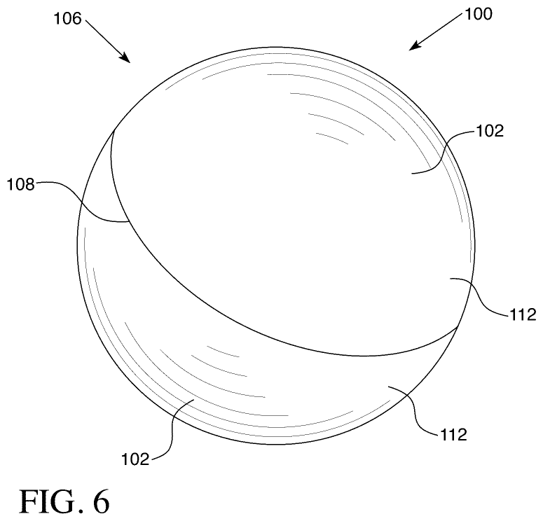

As shown in FIGS. 1-6, a pet toy 100 in accordance with the present invention includes a clamshell 106 having a living hinge 104 that allows the clamshell 106 to open and close. The clamshell includes two hemispheres 102 coupled together through the integral hinge 104. The entire pet toy 100 is a single, unitary piece made of the same material throughout. The pet toy 100 is moveable between a closed configuration, shown in FIG. 6 and an open configuration, shown in different stages in FIGS. 1-5. In the closed configuration, the clamshell 106 is a hollow ball or sphere having an inner cavity. The ball shape and light weight makes the pet toy 100 easy to throw.

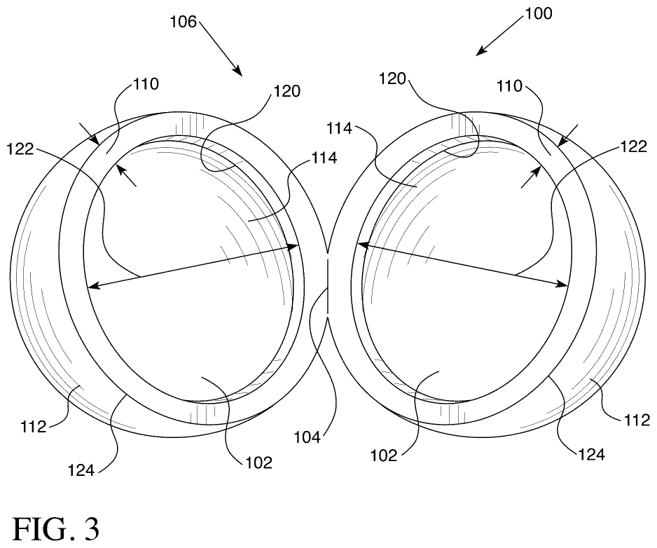

Each one of the half spheres 102 includes a convex outer surface 112 and a concave inner surface 114. When the clamshell 106 is in the closed configuration, the outer surfaces 112 form a substantially continuous spherical exterior interrupted only by the slit 108. That is, the outer surface of the clamshell 106 in the closed configuration is uninterrupted by protrusions, tabs, clamping mechanisms, or the like. The slit 108 (shown in FIG. 6) extends through the wall thickness 110 (shown in FIG. 3) of the clamshell 106. The slit 108 extends around most of the circumference of the sphere, corresponding to the separation between the two half spheres 102 where they are not connected by the living hinge 104. In one example, the slit 108 extends around 70%-95% of the circumference of the sphere. When the clamshell is in the closed configuration, the slit 108 appears as a narrow line or seam on the outer surface of the substantially spherical form, with the outer surface remaining otherwise continuous and smooth. The slit 108 represents the sole interruption to the otherwise complete spherical outer surface when the clamshell 106 is in the closed configuration.

In operation, the slit 108 cooperates with the living hinge 104 to enable the toy 100 to flop open freely during flight through the air and upon impact with a surface. Because the clamshell 106 lacks a locking mechanism or closure device to maintain the half spheres 102 in the closed configuration, the slit 108 permits uninhibited separation of the half spheres 102 about the living hinge axis when subjected to aerodynamic forces or impact forces. In one example, the living hinge 104 is constructed so that the clamshell 106 is biased to be in the closed configuration.

The outer surfaces 112 may be smooth to reduce air resistance during flight, or may include shallow surface texturing such as dimples or ridges that affect the aerodynamic properties of the toy 100. In one embodiment, the outer surfaces 112 are substantially smooth with a matte finish that provides adequate grip for a pet's mouth without being abrasive.

The inner surface 114 of each half sphere 102 faces the interior cavity of the clamshell 106. In various embodiments, the inner surface 114 includes a textured finish comprising raised nubs, ridges, or bristle-like projections that contact a pet's teeth and gums during chewing and mouthing of the toy 100. These textured elements may have heights ranging from approximately 1 millimeter to approximately 5 millimeters and may be arranged in regular patterns or random distributions across the inner surface 114. A textured inner surface may provide a teeth cleaning function by mechanically removing plaque and debris from the pet's teeth during normal play activities. Alternatively, the inner surface 114 may be smooth and free from protrusions.

The wall thickness 110 of each half sphere 102 extends between the inner surface 114 and the outer surface 112. The wall thickness 110 may be between approximately 3 mm and approximately 8 mm in order to provide sufficient structural support while maintaining the flexibility required for operation of the living hinge 104. The living hinge 104 has a reduced thickness compared to the wall thickness 110 of the half spheres 102, which allows the living hinge 104 to flex repeatedly without fracturing. In some examples, the living hinge 104 is reinforced with one or more additional layers of material.

The two half spheres 102 are the same shape and size as each other. The peripheral edge 124 of each half sphere 102 is in the shape of a circle. The diameter 122 of each half sphere 102 may be about 2 to 4 inches. The circumference of the peripheral edge 124 of each half sphere 102 may be approximately 6 to 13 inches. In the closed configuration, the peripheral edges 124 of the two half spheres 102 are positioned in direct contact with one another, with the circular peripheral edge 124 of one half sphere 102 being substantially aligned with and proximate to the circular peripheral edge 124 of the other half sphere 102. In the open configuration, the two half spheres 102 are pivoted apart about the living hinge 104, exposing the interior surfaces 114 of both half spheres 102. Further, when the clamshell 106 is in the open configuration, the peripheral edges 124 of the half spheres 102 are in direct contact with each other in the area of the living hinge 104, as shown in FIGS. 1-5.

The living hinge 104 is an integral flexible connection zone formed between the half spheres 102, providing a continuous pivoting mechanism that enables relative rotational movement between the two half spheres 102. The living hinge 104 is configured as a unitary portion of the monolithic toy body, being formed from the same flexible polymeric material composition as the half spheres 102 during a single molding operation.

The living hinge 104 operates through material deformation, wherein the molecular structure of the flexible material permits repeated bending cycles without fracture or permanent deformation. When external forces are applied to either half sphere 102, the living hinge 104 undergoes elastic flexion, allowing the toy to transition between a closed spherical configuration and an open configuration where the half spheres 102 are displaced angularly from one another. This flexural response occurs during flight trajectories when aerodynamic forces act upon the toy, and upon impact with surfaces or during canine interaction. The clamshell 106 may be biased to be in the closed configuration.

The pet toy 100 may be provided in different sizes to accommodate dogs of various sizes. For example, a pet toy 100 having a diameter 122 of 2 inches may be preferable for a small dog, while a pet toy 100 having a diameter 122 of 4 inches may be preferable for a large dog.

The two half spheres 102 may include a lip 120 around the peripheral edge 124 to facilitate handling by the pet and/or the human. The lip 120 protrudes inwardly towards the inner surface 114 of each of the half spheres 102. Alternatively, the lip 120 may protrude outward.

In other examples, rather than having two half spheres 102 coupled together, the pet toy 100 may have other shapes. For example, the pet toy 100 may include two cubes, two cones or two pyramids coupled together.

The entire clamshell 106, including the two half spheres 102 and the integral hinge 104, is a single, unitary, integrally formed piece. As such, the entire clamshell 106 is made of the same material throughout. The pet toy 100 is made of a single, continuous unit of material that is semi-flexible, light in weight for throwing, and safe for a pet to chew. The material of the pet toy 100 is additionally non-toxic and prevents or minimizes damage to the pet's teeth and mouth. Further, the material of the pet toy 100 may be BPA-free, phthalate-free, latex-free, tack-free, and non-adhesive. For example, the pet toy 100 may be made of silicone, natural or synthetic rubber, flexible polymers, or the like, or a combination thereof. The pet toy 100 may be made by injection molding, compression molding, casting, thermoforming, 3D printing, or the like.

The pet toy 100 is semi-rigid and configured to deform upon impact but return to its manufactured shape. Thus, the pet toy 100 generally maintains its shape during play. The material of the pet toy 100 may be impregnated with a smell or taste that is pleasing to the pet.

In alternative embodiments, the toy 100 may include one or more apertures formed through the wall thickness 110 of one or both half spheres 102. These apertures may serve multiple functions, including reducing the overall weight of the toy 100, creating whistling sounds during flight, and providing locations for attaching ropes or other accessories. The apertures may be circular, elongated, or other shapes, with diameters or widths ranging from approximately 5 millimeters to approximately 20 millimeters.

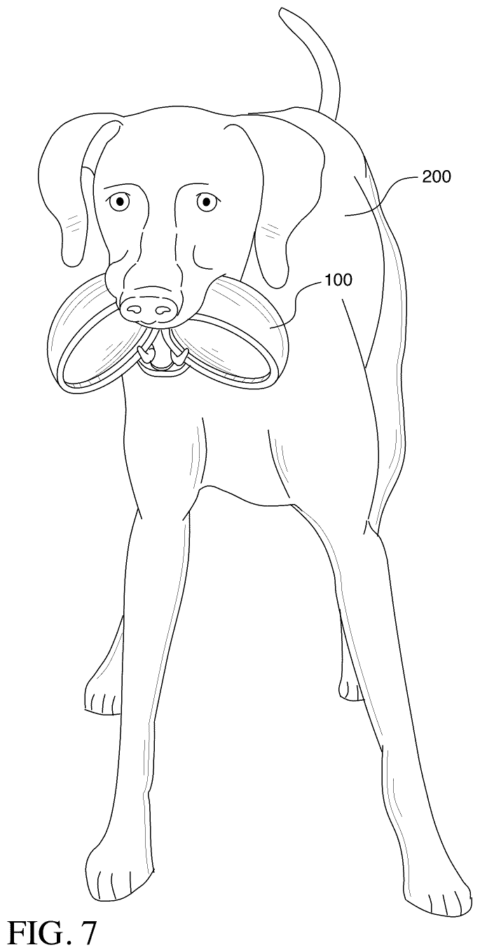

FIG. 7 depicts the pet toy 100 in use. A dog 200 is carrying the pet toy 100 around the integral hinge 104 and the pet toy 100 is clearly easier for the dog 200 to hold than a tennis ball or other similar conventional toy.

The toy 100 is designed to function within the context of interactive play between a human handler and a canine companion. During operation, the user grasps the pet toy 100 and propels it through the air toward or past the dog. The clamshell configuration of the toy 100 produces rotational and tumbling movement during flight, which serves to capture the dog's visual attention and engage its natural pursuit behaviors. The toy 100 may be thrown while in either the open or closed configuration, providing flexibility in use patterns.

Upon contact with the ground or other surfaces, the toy 100 may transition from a closed state to an open state due to the absence of a latching mechanism between the two half-sphere portions 102. This characteristic allows the toy 100 to assume various orientations upon landing. The three-dimensional geometry of the clamshell design prevents the toy 100 from resting flat against the ground surface, which facilitates retrieval by the dog. The canine can grasp the toy 100 at multiple points, including the living hinge region 104 connecting the two halves 102 or around the curved surfaces of the half-sphere portions 102.

The optional lip feature 120 extending around the peripheral edges 124 of the half spheres 102 provides additional purchase points for both the dog during retrieval and the human handler during throwing. The protruding lip 120 accommodates varying grip preferences and mouth sizes among different dog breeds. The toy 100 is configured for repeated cycles of throwing and retrieval, supporting sustained interactive play sessions between the handler and the animal.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present) , and both A and B are true (or present) .

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A pet toy comprising:
a clamshell comprising two half spheres coupled together with a living hinge, the clamshell having an outer surface, an inner surface, and a wall thickness,
wherein the clamshell is configured to move between a closed configuration and an open configuration,
wherein the clamshell in the closed configuration is a sphere having a circumference and the outer surface of the clamshell in the closed configuration is continuous and interrupted only by a slit that extends through the wall thickness of the clamshell around a portion of the circumference, and
wherein the clamshell is made of a single, integrally formed piece.

2. The pet toy of claim 1, wherein the clamshell is made of rubber or silicone.

3. The pet toy of claim 1, wherein each one of the two half spheres comprises a lip around a peripheral edge thereof.

4. The pet toy of claim 1, wherein the outer surface of the clamshell is smooth.

5. The pet toy of claim 1, wherein the inner surface of the clamshell is smooth.

6. The pet toy of claim 1, wherein the outer surface of the clamshell has a rough texture.

7. The pet toy of claim 1, wherein the inner surface of the clamshell has a rough texture.

8. The pet toy of claim 1, wherein the circumference of the sphere is approximately 6 to 13 inches.

9. The pet toy of claim 1, wherein the slit extends around 70%-95% of the circumference of the sphere.

10. The pet toy of claim 1, wherein the two half spheres are the same size and shape as each other.

11. The pet toy of claim 1, wherein the clamshell is made by injection molding, compression molding, thermoforming, or 3D printing.

12. The pet toy of claim 1, wherein the living hinge is configured to bias the clamshell in the closed configuration.
